(19) United States
(12) Patent Application Publication
(10) Pub. No.: US 2007/0248232 A1
(43) Pub. Date: Oct. 25, 2007

(54) CRYPTOGRAPHIC KEY SHARING METHOD

(75) Inventors: Kevin R. Driscoll, Maple Grove, MN (US); Patrick S. Gonia, Maplewood, MN (US); Joseph John Kimball, Columbia, MO (US); Thomas L. Phinney, Glendale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/279,235

(22) Filed: Apr. 10, 2006

(51) Int. Cl. H04L 9/00

(52) U.S. Cl. 380/280; 713/153; 713/171

(57) ABSTRACT

A system for sharing secure keying information with a new device not of a secure wireless network. The keying information may be used for encryption and provided to the new device in a manner which is not susceptible to exposure outside of the secure network. The keying information shared with the new device may be regarded as a birth key. Upon appropriate provision of the birth key, the new device may request with a birth key encrypted message via a communication mode exposed to potential adversaries to be added to the secure network.

### BACKGROUND

The present invention pertains to wireless networks, and particularly to secure wireless networks. More particularly, the invention pertains to authorization aspects of bringing in new entities to the secure wireless networks.

### SUMMARY

The present system may have a secure wireless infrastructure with a key server acting as a key distribution center. The key server may be the core of the network, securely admitting new nodes, deploying and updating keys and keeping track of any secure communication sessions in progress. Here, the present invention may better sustain security by including sharing a birth key between the key server and a newly installed device. An approach may assume that the installer has a personal digital assistant, keyfob, authentication device, or the like, that is trusted by the key server. There may be several options for providing the key.

### BRIEF DESCRIPTION OF THE DRAWING

FIG. 1 is a block diagram of a wireless sensor network utilizing the network components;

FIG. 2 is a flow chart illustrating the steps taken in the formation of a secured wireless sensor network;

FIG. 3 is a flow chart illustrating the steps taken during a communication session with respect to a communication session key; and

FIGS. 4, 5, 6, 7 and 8 are schematics of illustrative examples of approaches for incorporating a new device into a secure communication system.

### DESCRIPTION

Wired sensors have been used in many applications. One application for wired sensor networks has been industrial monitoring. A wired sensor may be used to monitor machinery that would not be easily accessible by a technician. However, wired sensors may bring a set of inherent drawbacks, most notably lack of portability. Sensor research has recently turned towards the use of wireless sensors in place of the existing wired sensors.

A key objective of wireless sensor development has been the design of wireless solutions appropriate for the above described industrial sensing, monitoring and control applications. These solutions aim to make the wireless sensor communication reliable enough in an industrial setting so that existing wired sensors may be replaced by wireless sensors. This change should be transparent to the sensing or control application, which means that wireless devices need to be effectively integrated and such communications need to be as good as wired communications.

Several critical to quality (CTQ) factors for designing this wireless communication from the sensor to the control center may be identified via voice of the customer analysis. These CTQ's may include, but are not be limited to, reliability, scalability, low-power consumption, low integration cost, security, auto-configuration, latency, easy maintenance, integration/compatibility and an agreed upon communications standard.

Some of the CTQ's may be described in the following. As to reliability, wireless communications appear to be inherently unreliable due to fluctuation of RF signal strengths and due to interference. The customer, however, should require the wireless communications to have reliability—“as good as a wire”.

As to scalability, a system should be highly scalable, handling thousands of sensors without requiring system re-configuration. As to low power, power consumption should be low enough in battery-powered devices to enable service intervals greater than three years.

As to low cost, an overall system cost and installation cost should be less than one-half of the equivalent wiring installation cost. As to security, the system should be highly secure against attacks such as spoofing and eavesdropping.

As to auto-configuration, the system and device installation should be extremely easy—“plunk and play”. As to latency, sensor message delivery should have controlled maximum latency. As to maintenance, the system should be easy to maintain, and system diagnostics should be provided for easy problem detection and repair.

As to integration and compatibility, the system should be interoperable with a diverse set of device types, such as sensors and PDA's, integrated into existing control systems. As to the communications standard, the wireless system should be capable of becoming a defacto standard at least at the air interface to the sensor.

The present system may have a secure wireless infrastructure with a key server acting as a key distribution center. The key server may be the core of the network, securely admitting new nodes, deploying and updating keys, authentications, certificates, and/or the like, and keeping track of any secure communication sessions in progress. The terms secure, secured, and/or the like, may mean secret, confidential, and/or mean not to be available to outsiders of the secure or secured network. Building an infrastructure around the key server may provide for a protocol with an added feature such that centralized policies and software updates can be pushed from one single source. The capabilities of the key server may permit simplification of other nodes in the wireless network and of the security aspects of the communication protocol(s) that they share. This communication simplification may also act to reduce the energy requirements of the other nodes, which may be battery-powered to increase portability.

In one illustrative example, a secure or secured network may start with a key server. Mobile authentication devices may be bound to the key server. These authentication devices may act as intermediaries between the key server and new sensor nodes in the infrastructure. The authentication devices may carry cryptographic information from the key server to new sensor nodes that are not actively participating in the secured network. When a new sensor node or device is added to the network, an authentication device may pass cryptographic keying information from the key server to the new sensor node. The sensor node may use this keying information to authenticate itself to the key server and exchange a key. A secure or secured network may have members (e.g., devices) that can have secure communications among themselves. Devices that have not proper or permitted encryption or authentication for such secure communications are non-members (i.e., not members) of the network.

When an existing node (device) of the secure network wants to communicate with one or more other nodes (devices) in the network, it may ask the key server to create a key for a communications session between the nodes. The key server may create a specific key for the specific communications session and send it to the nodes identified as participating in the communications session. The key server may update the key periodically and redistribute it to the identified nodes of the communication session, or the nodes in a communications session may request an updated key from the key server at any time.

The key chosen for a communications session may be chosen by the key server in such a way that it is unrelated to any other communication session or node key within the secured network. Thus, if any node is compromised, the security of its active communications sessions may be compromised, but the security of the key server and the remainder of the secured network should remain intact. Any message sent during a communications sessions may be authenticated and optionally encrypted with a monotonic counter to prevent replay attacks. When a communications session is closed, the key server may consider the key associated with that session to be expired and no longer update the key.

When a node is removed from the secured network, the key server may cause all keys associated with that node to expire, and notify other members of the network of the expiration. This may assure that no messages are sent that are intended for a node that has dropped out of the secured network. When an authentication device is removed from the network, the cryptographic information associated with that device may be considered as expired. An audit may be performed to find each node that was installed by the removed authentication device, and those nodes may be brought back into the network by another authentication device.

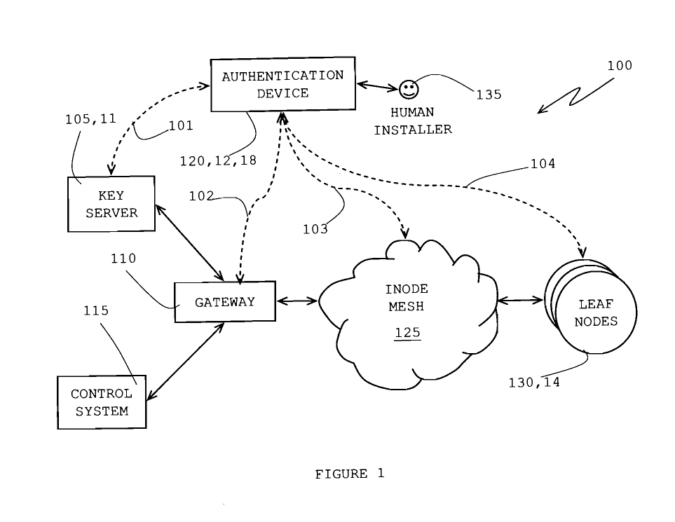

FIG. 1 illustrates wireless sensor network 100 utilizing the network components. Key server 105 may act as a central key distribution center. The key server, acting as the centralized trust authority of the network, may be physically placed in a secured location to protect the key server from a direct physical attack due to its critical role in the development and maintenance of the network 100. Key server 105 may act as a dedicated platform whose only job is to provide keys when required. For security purposes, its connection devices outside the network infrastructure may be limited to those necessary to perform that functionality. Its user interface may limit access to authorized administrators only.

Key server 105 may be connected to the rest of the wireless network 100 via gateway 110. The gateway 110 may be an interface between the wireless network nodes and the wired network components, such as the key server 105 and control system 115. Control system 115 may be the interface used to access the information being monitored by the sensor network.

Authentication device (AD) 120 (i.e., keyfob, personal digital assistant (PDA), portable device, intermediary device, liaison device, and/or the like) may connect directly to the key server 105 (i.e., key center, system security management center, key distribution center, and/or the like). The authentication device's role may be to act as a proxy for the key server 105 during device deployment. At first, a node entering the network does not necessarily share any keys with the secured network 100. Authentication device 120, physically proximate to a new node, may provide a bootstrap key (i.e., birth key, initial key, and/or the like), or a specific key used to join the secured network, to the new node via a non-RF channel or a weak non-exposed RF- or like-channel. Ideally, for security reasons, an optical channel or connection may be used for ease of certification. Authentication device 120 may use this same non-RF channel to communicate with the key server 105. Links 101, 102, 103, and 104 (generally out-of band) may be non-RF or linked, non-exposed to adversaries and/or non-members or non-components of the secured network 100, except the entity to which the communication is directed or intended. Some or all of the links 101, 102, 103 and 104 may be of the same link.

A secure communication mode or path may be a wireless channel, link or band (generally “exposed” which may mean that the mode or path is subject to eavesdropping by adversaries) where communications are encrypted or otherwise in another manner made unintelligible to eavesdroppers. A non-secure communication mode or path may be a non-wireless, out-of band, or non-exposed wireless channel or link where communications may be encrypted or not encrypted.

Directly connected to authentication device 120 through an optical communications or other out-of band link 104 may be leaf nodes 130. Leaf nodes 130 may be responsible for monitoring, sending and receiving the actual data being collected. Leaf nodes 130 may be low-cost, low resource consuming nodes. They may have enough volatile memory to store a key encryption key received from the key server 105 as well as to provide for firmware updates in the field. Leaf nodes 130 may also have a minimal external interface to allow an installer 135 to stimulate installation and to verify proper installation. This interface may be as simple as one button and one LED.

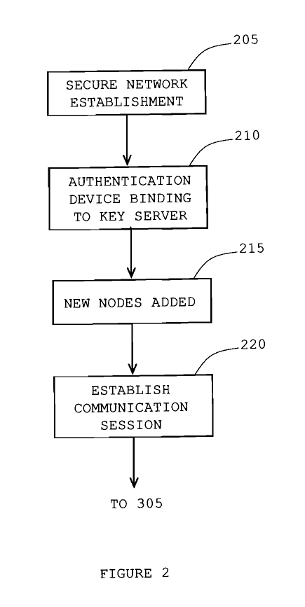

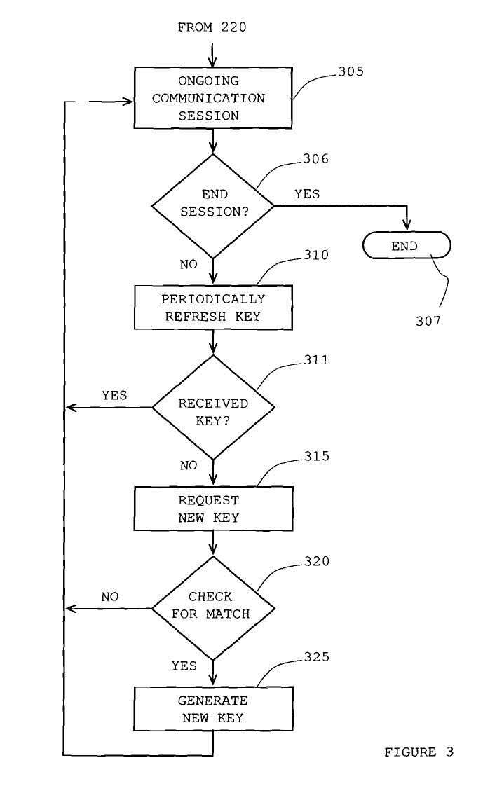

Between gateway 110 and leaf nodes 130 may be an infrastructure node (INode) mesh 125. The INode mesh 125 may be comprised of infrastructure nodes. The infrastructure nodes may be line-powered relay nodes which communicate with leaf nodes 130 and other infrastructure nodes. The infrastructure nodes may utilize communication sessions to retrieve information from leaf nodes 130 to report to the control system. Communication sessions, as well as the steps taken to form the secured network and begin a communication session, are further shown in FIG. 2 and FIG. 3.

FIG. 2 illustrates a flow chart of the steps taken in the formation of a new secured wireless sensor network 100. In step 205, the secured network 100 may be established. Establishing a new secured network may begin with the initialization of a key server 105. A configurable key server may be provided with a set of configuration parameters, such as a specification of how authorized administrators will authenticate themselves to the key server thereafter.

A configuration of the first key server 105 may initiate the new secured network 100. Networks in high-availability settings should have at least one other key server serving as a hot spare. The initial key server may be responsible for coordinating the replication of the critical security data to the other key server(s). The key server may be configured and attached to the network; then, as nodes (devices) are commissioned and join the secured network, the key server may add them to its database.

In step 210, the authentication devices 120 may be bound to the key server 105. The authentication devices may act as proxies to the nodes 130 being deployed in the field, by bringing them into the secured network 100.

In preparation, before deploying a set of new nodes, the authentication device 120 may be brought to the key server 105 and connected to it by an out-of band technique (e.g., optical, IR, serial cable) 101. The key server 105 may be told which wireless network will be receiving new nodes. The key server may use its high-quality entropy source (for providing a high unpredictability) to generate a key generation key (KGK) which it transmits to the authentication device 120 and saves locally. Similarly the key server may transmit the network ID and the relevant network key. The authentication device 120 may also zero its key generation counter. The authentication device may generate keys by encrypting its 128-bit counter using its 128-bit KGK, yielding a 128-bit result to be used as a new key.

Adding a node (step 215) to the secured network 100 may be accomplished by establishing a trust relationship between the new node and the network's key server 105 at device deployment. In node authentication, assurance of the claimant's identity may usually require the claimant entity to provide corroborating evidence—credentials—to the verifier entity. In this case, each node may be introduced to the key server 105 when it is deployed, corroborating the node's identity to the key server (and vice versa).

To establish trust between the key server and a new node (new device), the human installer 135 may use a handheld authentication device 120 to inject a bootstrap key (birth key) into the new node. Possession of the bootstrap key may authenticate the new node and the key server 105 to each other. A two-way optical link (out-of band or non-band) 104 between the authentication device 120 and new node 130 may be used for key injection.

The installer 135 may next press the button on the authentication device 120 telling it to begin deployment. The authentication device may generate a bootstrap key for the new node by encrypting its counter using the KGK, then incrementing the counter. The authentication device 120 may also update its KGK by again encrypting the counter using the current KGK, replacing the current KGK with the resulting value, and incrementing the counter again. Next, the authentication device may transmit the bootstrap key, network ID and the relevant network key to the new node. An error correcting integrity code may be included as well. The new node's optical transceiver may then blink a sequence indicating successful reception of the bootstrap information.

The new node may turn off its optical transceiver, and then use RF to send a request-to-join message to the key server 105 along with the bootstrap key. The request-to-join message may include necessary networking information (i.e., the new node's long address, its temporary short address, and so forth).

The key server 105 may have stored the original value of the authentication device's KGK, as well as recently used values of the KGK and the counter. The key server may generate a sequence of bootstrap keys, in the range after, and then slightly before, the most recently used values. The key server may follow the same procedure used by the authentication device to generate a bootstrap key and a replacement key generation key, as well as incrementing the counter. The key server 105 may deduce the bootstrap keys (and key generation keys) because it knows the starting state and the procedure the authentication device 120 goes through, as well as the most recently used bootstrap key if any. If no generated bootstrap key authenticates the message, the message may be discarded and the event logged.

Once the new node has successfully received its key-encrypting key (KEK), the node or the key server may use the shared KEK to corroborate the one's identity to the other. After this process, the key server 105 may trust the node 130 and the node may trust the key server. By extension transitively through the key server's session key generation services, the node also may form trust relationships with other nodes 130 that are trusted by the key server 105.

Once the node is trusted, the process may continue to step 220 in which a communication session is established. Cryptographic keys may be associated with the session; different sessions may have different keys, and a single session may be re-keyed periodically if it persists long enough. For example, each node may have a periodically-re-keyed permanent session with the key server 105 that is established when the node 130 joins the network 100; that session may persist for the operational life of the node.

A session which has two endpoints may be a unicast session; a session among a group of nodes 130 may be a multicast session. The cryptographic protection provided by the security protocol may apply uniformly to the entire session and all its endpoints. The use of symmetric (secret) key encryption with its requirement for shared keys may make it impossible to detect reliably the spoofing of one session endpoint by another endpoint of the same session. Thus, sender authentication may be restricted to authenticating that the sender is an authorized member of the session; there may be no consistent method for determining which one of the session's authorized senders is the actual sender of a given message.

When a node needs to communicate with one or more others in a session, the node 130 may request the session key (SK) for the session from the common key server 105, identifying the session by the session's assigned multicast address or the address of a unicast session's remote correspondent. At the first such request, the key server may validate the node's request to be a member of the session and, if acceptable, generate a new key for the session, escrow it locally, and send it to the requesting node. Each node 130 may share a unique key encrypting key (KEK) with the key server 105, and whenever the key server sends a key to a node, the key may be encrypted under the node's KEK.

Each successive request by another node may result in the key server's validating that new node's request to be a member of the session and, if acceptable, retrieving the locally escrowed key and sharing it with that new requesting node encrypted under that node's own private KEK.

After the communications session is established at step 220, the process flow may continue to FIG. 3 as an ongoing session at step 305. If none of the nodes involved in the session has requested the session to be ended at stage or step 306, the process may continue to a key refresh stage 310. If one of the nodes involved does request a session to be terminated, which may be at stage 307, then the key server 105 may notify the involved nodes and cancel the session key.

Session keys should be refreshed relatively frequently during the lifetime of the session (e.g., daily, weekly, monthly). This may serve to limit both the amount of data encrypted under a given key which is available to an attacker, and the time period during which a cracked key is useful for active attacks (e.g., tampering, forging, and spoofing).

Thus, in step 310, the key server may quasi-periodically send a new version of each session key to each participant in the given session; this may be called “re-keying”. If the key server is unavailable, the nodes in the session may generate a new session key from the current one; this may be called “key update”, or it may be a sort of key origination.

Re-key messages might not reach all participants in a session simultaneously. To accommodate this, during a key changeover, a node may maintain an “active” session key and an “alternate” session key. A message that was wrapped with the immediate next (or previous) version of the key may thus be unwrapped. Also, each message may include a 2-bit ‘keyState’ field so that correspondents are aware of the node's key-changeover status.

Each key may have a two-part numeric value associated with it, the key epoch, which is the “number of re-keys” value provided with the last key for the session by the keys server, coupled with a count of the number of times that key update was applied to that key to reach the current key. (For those keys provided by the key server, this latter count of update cycles should be always zero.) The first component of the key epoch field may monotonically increase with successive keys generated by the key server, with a discontinuous increase in value for the first key of each session provided by a replacement key server.

Quasi-periodically, if the key server has not re-keyed a given session or the members have not received a key (step or stage 311), each member of a session may request a re-key for the session from the key server (stage 315). Each such request may be accompanied by an indication of the current key epoch in use by that requester; each such request may also start a repetitive timer that will trigger repeated re-keying requests to the key server 105, followed eventually by the backup key-update action if necessary.

Upon receiving such a request, the key server may retrieve the last key escrowed locally for the session and do a comparison with the reported key epoch (step 320). If the reported key epoch corresponds to the last key generated by the key server for the session, the key server 105 may generate a new key (step 325), escrow it locally, and return it to the requester (encrypted under the requesting node's KEK), together with the numeric key epoch of the new key. Otherwise, the key server 105 may return the current key for the session (encrypted under the requesting node's KEK), together with the numeric key epoch of the just-returned key. Either way, the node that received the new key may note its availability, cancel the timer that is monitoring key reception, and start a timer that will eventually trigger use of the new key.

When a node 130 that is participating in a communications session has received a new key for the session, it may indicate that status in the keyState field of all messages it sends on the session connection. Other nodes 130 in the session that receive those messages may note that a new session key exists and, if they have not already done so, may send a message to the key server 105 requesting the new session key for themselves.

Once the process returns back to the ongoing communications stage, step 305, the process may repeat. Again, the nodes 130 may request the communication session to be terminated, or the keys may again be refreshed.

Wireless systems provide many benefits but should be continuously secure. Such wireless security may depend on sharing cryptographic secrets (e.g., keys, certificates, authentications, and/or the like) which is a basis for establishing trust. Securely sharing an initial (birth) key between a system security management device (key server) and a newly installed device may be difficult or inconvenient for the device installer.

The present invention may include sharing a birth key between the key server (KS) and a newly installed device. An approach may assume that the installer has a PDA (or keyfob, authentication device (AD), portable device, intermediary, liaison device, PDA, and/or the like) that is trusted by the KS. There may be various options. A hand held PDA may either get a key from the device and then give it to the KS, or get the key from the KS and give the key to the device. Since there is no prior key (this is the birth key), the transfer between PDA and device should be unencrypted. On the other hand, the messaging between the PDA and the KS may be encrypted if in RF form (i.e., band). As such, an unencrypted transfer should not be carried over the wireless link which could be listened to by an attacker. Rather an out-of band channel (e.g., an optical link, wire connection, and/or the like) should be used. A very low-power wireless RF connection (i.e., a whisper mode not detectable or listenable by an adversary or attacker) may be used. Minimal requirements should be placed on a device being installed in order to minimize the impact on device cost.

The invention may be a low-cost, low-impact way of conveying keys between a central key distribution center and a low-cost device that uses wireless communications which can be readily eavesdropped.

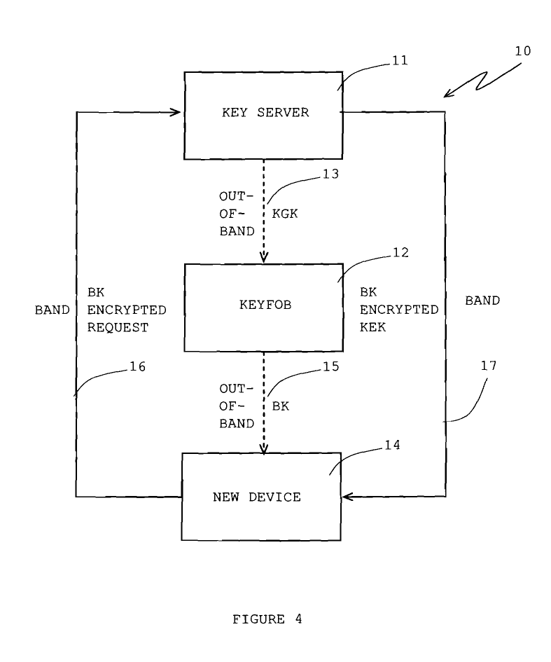

There may be several approaches for realizing the present invention in the secure wireless network 100. As to whether one approach is better than another may depend on circumstances relative to an application of the approach. As to a first approach 10, schematically outlined in FIG. 4, in a preparation step, a key server (KS) 11 may provide a key generation key (KGK) to a physically proximate keyfob 12 via an infrared (IR) link 13. Item 12 may be a portable device, PDA, intermediary device, liaison device, authentication device, or the like. There may be numerous items 12 in the secure network. Link 13 may be another optical channel, wire connection, low-power RF, internet, or other out-of band link. The KS 11 may use a high-quality entropy source for the keys it generates. A counter in the keyfob 12, used in the keyfob's key generation algorithm, may be zeroed or initialized with a random value from the KS 11, at a preparation step. The counter, the KGK, and the algorithm used by the keyfob 12 for key generation may be known by the KS. At each key injection, the keyfob 12 may be brought to a new device 14. The keyfob 12 may encrypt its counter value with the KGK to generate an individual bootstrap key BK (i.e., birth key or boot key) for (each) new device 14. The keyfob 12 may then increment the counter value. The keyfob 12 may next encrypt a new counter value with the KGK, thereby generating another key KGK′, with which the keyfob 12 replaces its KGK value. The keyfob 12 may then increment the counter value a second time. A bootstrap (birth) key (BK) may be transmitted by an out-of band 15 (e.g., generally an optical link or electrical connection) to the new device (ND) 14. The new device 14 may transmit a message to the KS 11 via an RF band 16, such as asking to join the secured network. The message may be authenticated (or encrypted) using the KGK or BK. The KS 11 may authenticate the received message based on trials of likely BK values, using its knowledge of recent values of the counter and the KGK. After the authentication succeeds, revealing a BK value to the KS 11, the KS may generate a KEK, encrypt it with the BK and send it back to new device 14 via an RF band 17. Authenticated with the BK, the device 14 may now have its unique KEK. The keyfob 12 could simply keep a list of keys from the KS 11 rather than generating them. The keyfob 12 should securely erase the keys as they are used.

The keyfob 12 may have time-limited keying or count-limited keying so that the current load of information is only good for a certain period or a number of installs. The keyfob 12 may also use time since re-synching with the KS 11 (rather than the counter) may be input to generating BK's. The time may be enforced by the KS 11 and need not be kept by the keyfob 12. The keyfob 12 (or the new device 14) could include an LCD that allows a tag name or functional ID to be viewed and selected for use by the device 14 at the same time as it is keyed. The keyfob 12 may get a tag name list from the KS 11. The keyfob 12 may be used to insert location information into the device 14 along with the boot key (i.e., BK). The device 14 may accept the key and location information only as a pair from the keyfob 12 to make location information secure.

This first approach 10 may be described as a system or network 100 for sharing secret keying information between a device of a system employing cryptographically or physically (or both) secured communications and a device 14 not yet a party to the secured communications network 100. The approach 10 may apply to a system of devices with permanent or intermittent secured communication mechanisms between and among subsets of the devices (of a system), such that one or more devices may function as a key distribution center (key center or key server 11) which can generate and share secret keying information with other devices of the system via the communications mechanism. A secured communications path may exist at least intermittently between any device and at least one key center 11 device using the secured communications mechanism. Some of the devices may be capable of communications using a channel (i.e., band) which is subject to eavesdropping by adversaries (“an exposed channel”).

A portable device 12 may be capable of communication with a key center 11 via the secured communications approach of the system 100 or with transmission over distances on the order of meters or less using wired or wireless communications techniques (such as an out-of band link 13) that are difficult to detect at greater distances. There may be another device 14 intended for inclusion in the prior system of devices (“the new device”), such that the device's primary mode of communications is a communications channel subject to eavesdropping by adversaries. This communications channel may require protection against an attack. The new device 14 may have an additional short-range optical or electrical manner 13 for reception of information from a physically proximate portable device. To bring in a new device, one may begin with having a key center 11 generate secret key generation information with high entropy (unpredictability). The key center 11 may communicate that secret key generation information to a portable device 12, using either physical or cryptographic techniques to secure that communication. At each instance of its use for commissioning a new device, that portable device 12 may use its current secret key generation information to generate new keying material for the new device in a mathematical manner that makes inference of the secret key generation information from the new keying material computationally infeasible. Then, the new keying material may be communicated to the new device 14 through the wired, optical, or wireless limited-distance transmission mechanism 15 for which the new device has a corresponding reception mechanism. The new keying material may be erased in the portable device. A cryptographically-strong function may be applied to the current secret key generation information, replacing that information with an output of that cryptographically-strong function. So that upon receipt by one of the system's key centers of communications from the new device 14, the key center 11 can sequence through the numerically-small sequence of new keying material sets that the portable device 12 could have generated, attempting to cryptographically verify the received message using each set until the proper set is detected. It may also verify by a subsequent cryptographically-protected message exchange with the new device 14 that the correct set of keying material has been inferred.

The short-range communications of secret keying information from the portable device 12 to the new device 14 may use an out-of band link such as a wired connection or an optical channel 15. The optical channel between the portable device and the new device may include an LED within the portable device, an appropriate photo-reception mechanism within the new device, and free-space transmission from the LED to a nearby photo-reception mechanism. The photo-reception mechanism may be an LED used in a reception mode as disclosed in a U.S. patent application Ser. No. 10/126,761, filed Aug. 19, 2002, which is hereby incorporated by reference. The optical channel 15 between the portable device 12 and the new device 14 may include, in lieu of free-space transmission from the LED to nearby photo-reception device, a multi-mode fiber optic medium (segment) with mechanical connectors or couplers or shrouds on at least one end of the fiber optic segment for mechanically affixing the fiber optic segment to either the portable device or the new device, or both.

The information signaled over the optical channel 15 between the portable device 12 and the new device 14 may also use a forward error correcting code (FEC). The short-range communications of secret keying information from the portable device to the new device may alternatively use wireless transmission at transmit power levels much lower than those of the system's normal wireless communications.

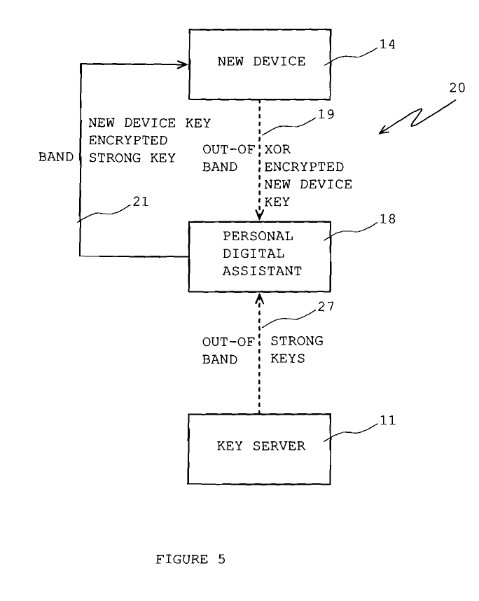

As to a second approach 20 in FIG. 5, a personal digital assistant (PDA) 18 may send a good quality (high entropy) key encrypted with a new device key via an RF band 21 while reading a lower quality key from a device 14 on its LED out-of band 19. Item 18 may be a keyfob, portable device, authentication device, intermediary, liaison device, or the like. Link 19 may be another kind of optical channel, wire connection, low-power RF, internet, or other out-of band link. In a minimum configuration, the new device 14 may need just an LED (in addition to the radio system to be secured). An LED on/off from the device 14 may be controlled based on a manufactured-in or internally-generated key (or combination thereof). The LED may emit this key during an installation process. One may use an RF band 21 input and LED (from of the device) out-of band 19 to get the key installed. Essentially one may Xor (or similarly encrypt) the RF-provided key with the LED state bit by bit. The attacker would not have access to the LED values. One could also run a PDA's radio transmitter in very low power “whisper” mode for additional risk mitigation. This may assume that the device 14 has limited entropy keys and PDA 18 has access to good quality or strong keys from the key server 11 via an out-of band conveyance 27.

This second approach 20 may be described as a system 100 for sharing secret keying information between a device of a system employing cryptographically or physically (or both) secured communications and a device 14 not yet a party to the secured communications. The approach may be for a system 100 of devices with permanent or intermittent secured communications mechanisms between and among subsets of the devices (“the system”), such that one or more devices may function as a key distribution center (“key center 11”) which can generate and share secret keying information with other devices of the system via the communications mechanism. A secured communications path may exist at least intermittently between any device and at least one key center 11 device using the secured communications mechanism. Some of the devices may be capable of communications using a channel (i.e., band) subject to eavesdropping by adversaries (“an exposed channel”).

At least one of the devices capable of communications on the exposed channel may be portable (“portable device 18”) and have an optical approach of reception from a physically proximate transmitting device. Another device 14 intended for inclusion in the prior system of devices (“the new device”) may have a primary mode (i.e., band) 21 of communication which is subject to eavesdropping by adversaries, and thus that mode may require protection against attack. The device 14 may have an additional short-range optical mode out-of band 19 of transmission to a physically proximate device 18.

The approach for combining within one of the system's portable devices may include secret keying information with high entropy (unpredictability) generated by a key center 11 within the system and communicated securely via a channel 27 to the portable device 18. It may also include secret keying information of lower entropy generated by the new device 14 and signaled by that optical mode out-of band 19 of transmission and an intervening optically conductive medium to the portable device 18, and communicating that information from the portable device 18 back to the new device 14 via the exposed channel 21 such that the communicated combination is secured by the lower entropy secret keying information provided to the portable device by the new device 14.

The exposed channel 21 may be a wireless channel, and the communications of secret keying information from the portable device 18 to the new device 14 via that wireless channel 21 may be a direct wireless transmission using transmit power levels (i.e., whisper mode) much lower than those of the system's normal wireless communications. The communications of secret keying information from the portable device 18 to the new device 14 may use some of the system's secured communications links in addition to an exposed channel 21.

The optical channel 19 between the new device 14 and the portable device 18 may include an LED within the new device, an appropriate photo-reception mechanism within the portable device 18, and free-space transmission from the LED to a nearby photo-reception mechanism. The optical channel 19 between the new device 14 and the portable device 18 may include, in lieu of free-space transmission from the LED to a nearby photo-reception mechanism, a multi-mode fiber optic medium (segment) with mechanical connectors or couplers or shrouds on at least one end of the fiber optic segment for mechanically affixing the fiber optic segment to either the portable device 18 or the new device 14 or both. The information signaled over the optical channel 19 between the new device 14 and the portable device 18 may use a forward error correcting code.

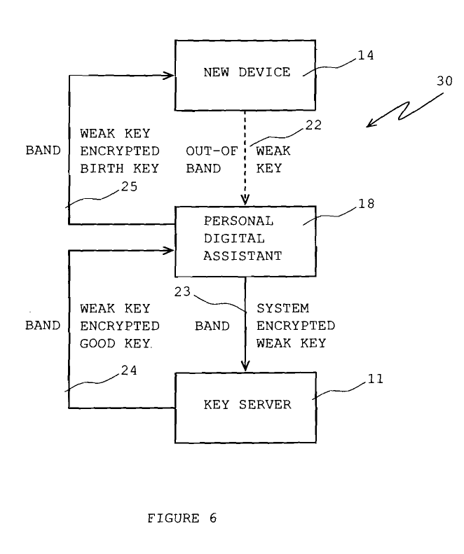

As to a third approach 30 in FIG. 6, a weak random key (as it may be generally difficult to generate good keys) in a new device 14 may be sent via an LED (out-of band 22 and using forward error correcting coding) to a PDA 18. Item 18 may be a keyfob, portable device, authentication device, intermediary, liaison device, or the like. Link 22 may be another kind of optical channel, wire connection, low-power RF, internet, or other out-of band link. The PDA 18 may be linked securely (e.g., using a system encryption) to a KS 11 via an RF band 23 with which to generate a good key for the device 14 and encrypt it using the device's key. The KS 11 may send the encrypted key to the PDA 18 via band 24. The PDA 18 may send the encrypted key via an RF band 25 to the device 14 which may be its birth key, possibly in whisper mode, and the erase the message in itself. The PDA 18 then need not be aware of the keys, so it does not have to be a so carefully protected device.

This approach 30 may be described as a system for sharing secret keying information between a device 14 of a system employing cryptographically or physically (or both) secured communications and a device not yet a party to the secured communications network 100. There may be a system network of devices with permanent or intermittent secured communication mechanisms between and among subsets of the devices (“the system”), such that one or more devices may function as a key distribution center (“key center 11”) which can generate and share secret keying information with other devices of the system via the communications mechanism. A secured communications path may exist at least intermittently between a device and at least one key center 11 device using the secured communications mechanism. Some of the devices may be capable of communications using a channel (i.e., band) subject to eavesdropping by adversaries (“an exposed channel”).

At least one of the devices capable of communications on the exposed channel may be portable (“portable device 18”) and have an optical approach (out-of band 22) of reception from a physically proximate transmitting device. A device 14 intended for inclusion in the prior system of devices (“the new device 14”) may have a primary mode of communication (a band 25) which is subject to eavesdropping by adversaries, and thus that mode may require protection against an attack. The device 14 may have an additional short-range optical mode (out-of band 22) of transmission to a physically proximate device, such as device 18.

This approach may include having the new device 14 generate secret keying information of low to moderate entropy, and having the new device 14 signal or transmit that keying information by the optical mode of transmission 22 via an intervening optically conductive medium to one of the system's portable devices 18. It may also include having that same portable device 18 securely communicate that low- to moderate-entropy secret keying information to one or more of the system's key centers 11 via a band 23, and having that key center 11 generate secret keying information with high entropy (unpredictability). Further, it may include having that key center 11 secure that new high-entropy secret keying information with the low- to moderate-entropy secret keying information originated by the new device 14, and having that key center 11 securely communicate that now-secured keying information back via a band 24 to one or more devices 18 in the system capable of communications with the new device 14 via an exposed channel (i.e., band 25). It may also include having at least one of those receiving devices forward the secured keying information to the new device 14 via the exposed channel (band).

The receiving device of the system that forwards the secured keying information to the new device 14 via an exposed channel may be the same portable device 18. The exposed channel may be a wireless channel (band 25), and the communications of secret keying information from the portable device 18 to the new device 14 via that wireless channel 25 may use transmit power levels much lower than those of the system's normal wireless communications.

The optical channel 22 between the new device 14 and the portable device 18 may include an LED within the new device, an appropriate photo-reception mechanism within the portable device 18 and free-space transmission from the LED to a nearby photo-reception mechanism. The optical channel 22 between the new device 14 and the portable device 18 may also include, in lieu of free-space transmission from the LED to a nearby photo-reception mechanism, a multi-mode fiber optic medium (segment) with mechanical connectors or couplers or shrouds on at least one end of the fiber optic segment for mechanically affixing the fiber optic segment to either the portable device 18 or the new device 14, or both. The information signaled over the optical channel 22 between the new device 14 and the portable device 18 may use a forward error correcting code.

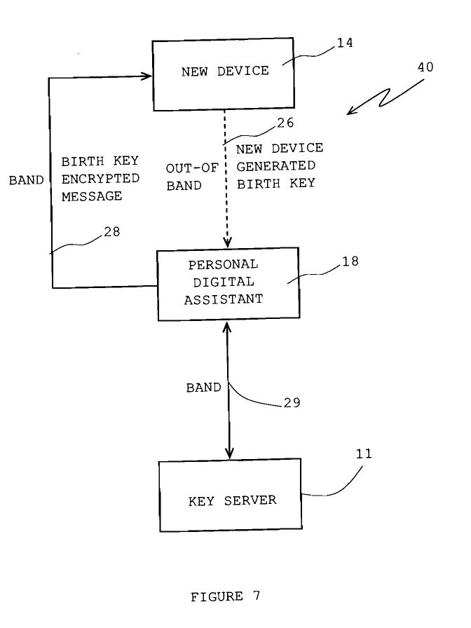

As to a fourth approach 40 in FIG. 7, a PDA 18 may read a key sent by the device 14 via its LED (out-of band 26). Item 18 may be a keyfob, portable device, authentication device, intermediary, liaison device, or the like. Link 26 may be another kind of optical channel, wire connection, low-power RF, internet, or other out-of band link. Device 14 may have a manufactured-in good entropy random number which may be used with an install-counter in its AES (advance encryption standard) engine to generate birth keys—one for each new device 14 install. New device 14 may send a random number generated birth key through an LED port with a forward error correcting code (FEC) via the out-of band channel 26. The FEC may be used to assure that the one-way transmission is correctly transmitted to the PDA 18. Local random entropy may be mixed in with the manufactured-in key before the key is given to the PDA 18 to evade or avoid an attack on the key manufacturing process. Then, the PDA 18 may send a birth key encrypted message to the new device 14 via an RF band 28. PDA 18 may transmit this information to a key center 11 via a band 29.

This approach 40 may be described as a system for sharing secret keying information between a device of a system employing cryptographically or physically (or both) secured communications and a device 14 not yet a party to the secured communications network or system 100. There may be a system of devices with permanent or intermittent secured communications mechanisms between and among subsets of the devices (“the system”), such that one or more devices may function as a key distribution center (“key center 11”) which can generate and share secret keying information with other devices of the system via the communications mechanism. A secured communications path may exist at least intermittently between any device and at least one key center 11 device using the secured communications mechanism. Some of the devices may be capable of communications using a channel (band) subject to eavesdropping by adversaries (“an exposed channel”).

At least one of the devices capable of communications on the exposed channel (band) may be portable (“portable device 18”) and have an optical channel (out-of band) 26 of reception from a physically proximate transmitting device. A device 14 intended for inclusion in the prior system of devices (“the new device 14”) may have a primary mode (band) 28 of communication which is subject to eavesdropping by adversaries, and thus that mode may require protection against attack. The device 14 may have the additional short-range optical mode (out-of band) 26 of transmission to a physically proximate device such as portable device 18.

This approach 40 may include having the new device 14 generate secret keying information from high entropy secret keying information introduced into the new device 14 prior to deployment, and low- to moderate-entropy secret keying information acquired by the new device 14 from its environment, and a count of the number of times that the device has generated such secret keying information. It may also include having the new device signal or transmit that generated keying information by the optical mode (out-of band 26) of transmission via an intervening optically conductive medium to one of the system's portable devices 18, and having that same portable device 18 securely communicate the secret keying information, received via an optical mechanism from the new device 14, to one or more of the system's key centers 11.

The optical channel 26 between the new device 14 and the portable device 18 may include an LED within the new device, an appropriate photo-reception mechanism within the portable device, and a channel 26 with free-space transmission from the LED to a nearby photo-reception mechanism. The optical channel 26 between the new device 14 and the portable device 18 may also include, in lieu of free-space transmission from the LED to a nearby photo-reception mechanism, a multi-mode fiber optic medium (segment) with mechanical connectors or couplers or shrouds on at least one end of the fiber optic segment for mechanically affixing the fiber optic segment to either the portable device 18 or the new device 14, or both. The information signaled over the optical channel 26 between the new device 14 and the portable device 18 may incorporate a forward error correcting code.

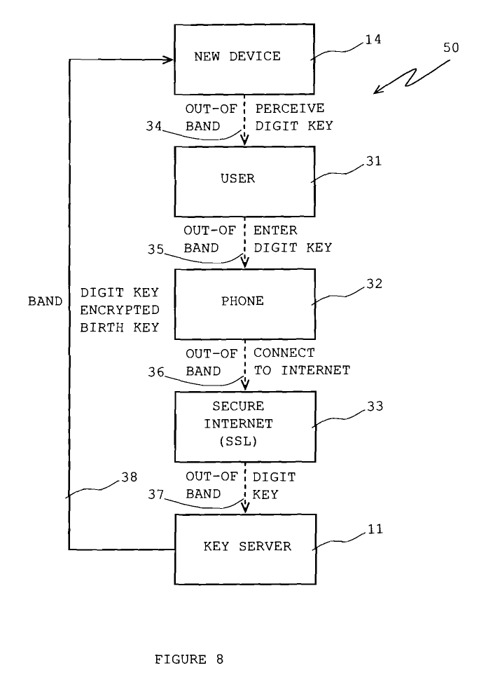

Another or fifth approach 50 in FIG. 8 shows a user 31 who may implement a phone 32 and a secure internet 33 to provide a key from a new device 14 to a key server 11. The new device may provide, for example, a series of hexadecimal digits to the user 31. These digits (which may be a new device 14 manufactured-in number or code, or other source of digits) may be conveyed as a key in an out-of band 34 manner via an LED in the form of a blinking light. The user 31 may read the digits from the LED blinks of light and enter them with keystrokes (out-of band 35) into a keyboard or pad of a telephone 32. Telephone 32 may be connected to an internet 33 via an out-of band 36 connection such as a hard wire connection, IR, tone signals or other out-of band technique. An out-of band technique could include a very low-range, undetectable by an outsider, RF signal. The output of the internet 33 may provide a secure transmission of the information, which may be the new device digit key, from the phone interface 36 to a connection or interface 37 for the key server 11. The out-of band connection or interface 37 may utilize items like those possible for the out-of band 36 connection. The internet 33 may use SSL (secure socket logic), a java application, or other approach for providing secure transmission of digit key information over the net. Instead of the internet 33, the new device key information may be conveyed from the phone 32 via an all telephone link or another secure data link (i.e., out-of band) between the user 31 and the key server 11. After receipt of the new device 14 digit key, the key server 11 may send a digit key encrypted birth key or message to the new device 14 via an exposed channel (i.e., a band 38), such as RF.

Other approaches, including variations of the approaches included herein, for secure provision of birth keys to new devices 14 to be brought in to a secure communication system or network of devices may be utilized.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. A system for sharing keying information, comprising:
a secure network comprising members; and
wherein:
at least one member is a key center;
at least one member is a liaison device;
the secure network comprises secure communication modes among the members;
the key center provides first keying information to the liaison device via a secure communication mode;
the liaison device generates second keying information from the first keying information;
the liaison device comprises a non-secured communication mode;
a non-member is connected with the non-secured communication mode of the liaison device;
the liaison device provides the second keying information to the non-member via the non-secured communication mode;
the non-member provides a message encrypted with the second keying information to the key center; and
the key center computationally derives the second keying information with the first keying information.

2. The system of claim 1, wherein the first keying information cannot feasibly be derived from the second keying information.

3. The system of claim 2, wherein the non-secure communication mode is unexposed to non-members other than the non-member connected with the non-secured communication mode of the liaison device.

4. The system of claim 3, wherein the first keying information has high entropy.

5. The system of claim 3, wherein:
the secure communication mode is a wireless channel; and
the non-secure communication mode is an optical channel.

6. The system of claim 3, wherein:
the secure communication mode is a wireless channel; and
the non-secure communication mode is an unexposed wireless channel.

7. The system of claim 2, wherein the first keying information and second keying information are deleted from the liaison device.

8. The system of claim 1, wherein the liaison device is a portable device.

9. A system for sharing keying information, comprising:
a key server; and
an intermediary device; and
wherein:
the key server provides a key generation key to the intermediary device via an out-of band link;
the intermediary device encrypts a value with the key generation key to generate a birth key;
the intermediary device provides the birth key to a new device via an out-of band link;
the new device sends a birth key encrypted message to the key server via a band link; and
the key server authenticates the message with the key generation key and the value at the intermediary device.

10. The system of claim 9, wherein:
the key server generates a key encryption key; and
the key server sends a birth key encrypted key encryption key to the new device.

11. The system of claims 10, wherein:
the value is from a counter; and
the key server authenticates the message from the new device based on trials of likely values and the key generation key.

12. The system of claim 11, wherein:
the band link is an RF band;
the out-of band link is an optical channel not exposed to others besides a sender and a recipient; and
the intermediary device is a keyfob.

13. The system of claim 11, wherein:
the band link is an RF band;
the out-of band link is an optical channel not exposed to others besides a sender and a recipient; and
the intermediary device is a personal digital assistant.

14. A system for sharing keying information, comprising:
a key server; and
a intermediary device; and
wherein:
the key server provides a first key to the intermediary device via a first out-of band link;
a new device provides a second key to the intermediary device via a second out-of band link; and
the intermediary device provides a second key encrypted first key to the new device via a band link.

15. The system of claim 14, wherein:
the band link is an RF band; and
the out-of band link is an optical channel.

16. The system of claim 15, wherein:
the first key is a high entropy key; and
the second key is Xor encrypted by the new device.

17. The system of claim 15, wherein:
the first key is a high entropy key; and
the second key is Xor encrypted by the intermediary device.

18. A system for sharing keying information, comprising:
a key server; and
a intermediary device; and
wherein:
a new device provides a first key to the intermediary device via an out-of band link;
the intermediary device provides the first key to the key server via a secure band link;
the key server provides a first key encrypted second key to the intermediary device via a band link; and
the intermediary device provides the first key encrypted second key as a first key encrypted birth key to the new device via a band link.

19. The system of claim 18, wherein:
the out-of band link is an optical channel; and
a band link is an RF band.

20. The system of claim 18, wherein:
the new device encodes the first key with forward error correcting coding;
the first key is a low entropy key; and
the second key is a high entropy key.

21. A system for sharing keying information, comprising:
a intermediary device; and
wherein:
a new device generates a birth key;
the device provides the birth key to the intermediary device via an out-of band link; and
the intermediary device provides a birth key encrypted message to the new device via a band link.

22. The system of claim 21, wherein:
the device encodes the birth key with a forward error correcting code;
the out-of band link is an optical channel; and
the band link is an RF band.

23. A system for sharing keying information, comprising:
a key server; and
wherein:
a new device provides a series of digits as a digit key to a user;
the user enters the digit key into a phone;
the phone provides the digit key to a secure internet via an out-of band link;
the secure internet provides the digit key to the key server via an out-of band link; and
the key server provides a digit key encrypted birth key to the new device.
